(19) United States
(12) Patent Application Publication
(10) Pub. No.: US 2015/0103396 A1
(43) Pub. Date: Apr. 16, 2015

(54) Antireflective Structures for Optics

(71) Applicants: Byron Zollars, Georgetown, TX (US); Steve Savoy, Austin, TX (US); Qizhen Xue, Austin, TX (US)

(72) Inventors: Byron Zollars, Georgetown, TX (US); Steve Savoy, Austin, TX (US); Qizhen Xue, Austin, TX (US)

(21) Appl. No.: 14/266,361

(22) Filed: Apr. 30, 2014

Related U.S. Application Data
(60) Provisional application No. 61/818,437, filed on May 1, 2013.

(51) Int. Cl. G02B 1/11; G02B 1/12

(52) U.S. Cl. CPC G02B 1/118; G02B 1/12
USPC 359/350; 216/24

(57) ABSTRACT

The disclosure relates to methods for the fabrication of randomly arranged, antireflective structures on surfaces of optical substrates and to optics having antireflective coatings comprising random surface structures.

### PRIORITY CLAIM

This application claims priority under 35 U.S.C. §119 to U.S. Provisional Application No. 61/818,437 filed May 1, 2013, which is incorporated herein by reference in its entirety.

### STATEMENT REGARDING FEDERALLY FUNDED RESEARCH

This invention was made with government support under SBIR Phase II contract number FA8650-12-C-5181, awarded by the United States Air Force. The government has certain rights in the invention.

### SUMMARY

This invention is in the field of optics, particularly in the area of antireflective structures for reducing the reflection of radiation from an optic.

A certain amount of light transmission loss occurs at an optical interface, for example the interface between air and a glass optic such as a lens or a window. Such losses are dependent on the refractive index of the optic material. Additional transmission losses can occur due to scattering at an optical interface that has irregularities with transverse sizes that are larger than the wavelength of incident radiation. In many instances it is desirable to maximize transmission, i.e., reduce the amount of transmission lost at the interface.

Transmission loss may be reduced by the application of, for example, thin film anti-reflective (AR) coatings on the substrate. Such coatings can be designed or chosen to enhance light transmission and reduce reflection at the optical interface. Single- or multi-layer coatings are available that consist of dielectric materials and reduce reflection through interference effects. Thin film AR coatings may suffer from adhesion problems, cracking, and other mechanical defects and they typically are effective over only a small range of incident angles.

Alternative AR surfaces employ sub-wavelength surface (SWS) structures on the optical substrate surface (surface texturization). One practical surface modification is a closely packed array of pyramidal or conical structures. As an incident electromagnetic wave traverses the length of the structures, it passes from a region (near the apices) where there is less material, with an effective refractive index close to 1.0, to regions (near the bases) where the region is almost entirely solid, having a refractive index close to that of the material comprising the structure. These AR systems mimic the sub-wavelength structures on the corneas of nocturnal moths, and so, are referred to as “motheye” or “moth-eye” structures or surfaces. The motheye structures effect a gradual transition of the refractive index from that of air to that of the optic substrate. Highly ordered motheye coatings have been fabricated by a variety of techniques including dry etching with the use of masks, block copolymer micelle nanolithography, interference lithography, and nanoimprint lithography. These techniques involve complicated processes and as a result are low throughput and costly.

Multispectral zinc sulfide (ZnS, CLEARTRAN™; Dow Chemical Co.) and zinc selenide (ZnSe) are materials used extensively as “hyperspectral” windows due to their good optical transmittance across the visible, 0.7-1.0 μm near infrared (NIR), 0.9-2.0 μm short-wave infrared (SWIR), 3-5 μm mid-wave infrared (MWIR), and 8-12 μm long-wave infrared (LWIR) spectral bands. Such windows or optics are used in sensitive multi-band sensors in aerospace platforms (missile, aircraft, UAV, rotorcraft, etc.). A disadvantage of using bare ZnS or ZnSe as a broadband window is that their relatively high refractive indices cause significant transmission losses at each material interface. Thin film antireflective AR coatings can be applied to mitigate losses in one or two spectral bands, but typically at the expense of transmittance in the other bands. Additionally, thin film AR coatings typically have poor transmittance at incident angles larger than 30° from normal incidence.

The inventors identified a need for patterned surfaces for ZnS and ZnSe windows and other window substrates to simultaneously obtain high transmittance of electromagnetic radiation over multiple spectral bands and over a wide range of incident angles.

This invention is based partly on the surprising discovery that random motheye surface structures, present on a buffer layer (e.g., AlN) on a transmissive optical substrate (e.g., a ZnS or ZnSe optical window), significantly improve the transmission of radiation over a broad range of the electromagnetic spectrum, and simultaneously, this improvement is effective over a very wide range of angles of incident radiation. In addition, in embodiments of the invention, the random surface structures do not cause scattering of the radiation, so optics of the invention are useful for imaging, for refractive correction (for example, as lenses), or as transparent windows.

In certain embodiments of the invention, methods are presented for the fabrication of randomly arranged, antireflective structures on a surface of an optical substrate. In certain aspects of the invention, such methods comprise providing a substrate, depositing a buffer layer on a surface of the substrate to make a buffer-coated substrate, depositing a metal film on the buffer layer, heating to effect rapid thermal annealing of the metal into nanoparticles, dry etching the buffer-coated substrate using the metal nanoparticles as a randomly arranged hard mask, and wet etching to remove the metal mask. In other aspects, randomly arranged, AR motheye structures are fabricated on two sides of a substrate.

Other embodiments of the invention provide optics having randomly arranged, AR motheye structures on one or more surfaces of an optical substrate. In certain aspects of the invention, the randomly arranged motheye structures are etched into the ZnS, ZnSe, or other substrate and have lower regions comprising substrate material and upper regions comprising buffer layer material, such as for example AlN. In other aspects, the etch depth of the motheye structures does not extend into the substrate, and the motheye structures comprise only buffer layer material.

In various aspects of the invention, the ratio of the surface structures' average height to the average distance between the centers of adjacent structures may range from at least 2 to about 12. In some embodiments of the invention the ratio is at least 2. In other embodiments the ratio is at least 4. In still other embodiments, the ratio is at least 6.

In embodiments of the invention, AR motheye structures enhance transmittance and reduce reflection and scattering of electromagnetic radiation through the optic on which they are present on the surface. In certain embodiments, transmittance is increased over a region of at least 2 octaves within the electromagnetic spectrum region of 350 nanometers (nm) to 18,000 nm. In some embodiments, AR motheye structures increase transmittance of electromagnetic radiation that strikes the surface of the optic with an incident angle from 0° (normal incidence) to 70°.

Other embodiments of the invention are discussed throughout this application. Any embodiment discussed with respect to one aspect of the invention applies to other aspects of the invention as well and vice versa. Embodiments described herein are understood to be applicable to all aspects of the invention. It is contemplated that any embodiment discussed herein can be implemented with respect to any method or composition of the invention, and vice versa. Furthermore, compositions of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1. shows measured reflectance as a function of angle for S- and P-polarized light incident on a surface with an AlN motheye (bottom two curves), and the computed (Fresnel) reflectance from a bare ZnS surface (top two curves), at a wavelength of 1.0 μm.

FIG. 2 illustrates numerically computed spectral reflectance of a ZnS surface patterned with an array of conical frusta with aspect ratio of 5, having a range of frustum parameter values (F), which is an indicator of sidewall slope.

FIG. 3 illustrates process steps required for fabricating random AR surface structures on ZnS, ZnSe, or other transmissive optical components.

FIG. 4A is a scanning electron microscope micrograph illustrating Ni dots created by rapid thermal annealing from a 17 nm initial Ni film. FIG. 4B is a scanning electron microscope micrograph illustrating Ni dots created by rapid thermal annealing from a 3.9 nm initial Ni film.

FIG. 5A is a scanning electron microscope micrograph illustrating Ni dots created by rapid thermal annealing. FIG. 5B is a binarized image of the micrograph in FIG. 5A.

FIG. 6 illustrates a brightness histogram of the micrograph in FIG. 5A, showing the bimodal distribution of image brightness and the Gaussian fits resulting from each population of pixel values.

FIG. 7 illustrates the radial average of the autocorrelation of the binarized image in FIG. 5B. The minimum of the autocorrelation is taken as the approximate radius R of a quasiperiodic “unit cell”.

FIG. 8 shows estimated Ni dot radius vs. initial Ni layer thickness, with various buffer layer materials.

FIG. 9 illustrates the transmission spectra, at normal incidence, of ZnS transmissive windows having random surface structures on a single side of the window and fabricated using an AlN buffer layer and etch masks made from Ni thin films with different initial thicknesses (3.9, 6, 10, and 20 nm).

FIG. 10 shows the measured spectral reflectance of P-polarization for an unpatterned ZnSe window (upper lines for angles of incidence from 0-60°, lower lines for angles of incidence from 70-80°) and a ZnSe window having random motheye surface structures as a function of angle from 20° to 80° and wavelength from 2 μm to 16 μm.

FIG. 11 shows the measured spectral reflectance of S-polarization for an unpatterned ZnSe window (upper lines) and a ZnSe window having random motheye surface structures (lower lines) as a function of angle from 20° to 80° and wavelength from 2 μm to 16 μm.

FIG. 12 shows a Ni dot etch mask for a double-sided ZnSe window, with average dot size of 200 nm.

FIG. 13A is a scanning electron micrograph showing post-etch random motheye surface structures on a ZnSe window. FIG. 13B is a photograph showing a finished ZnSe window with random motheye surface structures on two sides.

FIG. 14 illustrates the measured spectral transmittance of a ZnSe window with random motheye surface structures on both sides of the window (upper curve), compared to the measured spectral transmittance of a blank ZnSe window (lower curve).

### DESCRIPTION

The invention relates to methods for making optical elements with improvements that enhance the transmission of, and reduce the reflection and scattering of, electromagnetic radiation and to the improved optical elements. More specifically, the invention relates to improving transmission and reducing reflection and scattering by providing antireflective surface structures on the surface of an optical substrate. The methods and manufactures of the invention are particularly useful for reducing reflection of radiation across the visible, near infrared (NIR), short-wave infrared (SWIR), mid-wave infrared (MWIR), and long-wave infrared (LWIR) spectral bands. The methods and manufactures of the invention are useful for improving transmission of and reducing the reflection and scattering of radiation striking an optical surface from a wide range of incident angles. Embodiments of the invention are particularly useful for making transmissive optics, such as for example lenses and windows.

As used herein an “octave” on the electromagnetic spectrum refers to an interval or range of values on the spectrum in which the wavelength is doubled. For example, when starting at a wavelength of 200 nm, an interval of one octave would end at 400 nm. Similarly, when starting at a wavelength of 400 nm, an interval of one octave would end at 800 nm. A wavelength range from 200 nm to 800 nm represents 2 octaves. A wavelength range from 200 nm to 1,600 nm represents 3 octaves.

The “angle of incidence” or “incident angle” of radiation striking a surface of an optic is the angle that the radiation makes with a line perpendicular to the surface. Radiation striking perpendicular to the surface has an angle of incidence of 0°, also referred to as “normal incidence”.

For purposes of the invention an “aspect ratio” is defined as the height of a “pillar” or motheye structure or surface structure divided by the diameter of the base of the structure. Typically, surface structures made by methods of the invention have bases that substantially abut. As such, the “aspect ratio” of surface structures prepared by methods of the invention is substantially equivalent to the mean height of the surface structures present on an optic divided by the mean distance between the centers of the bases of adjacent surface structures. The distance between the centers of the bases of adjacent surface structures is also referred to as “base-base spacing”.

Surface modifications to transmissive optical substrates or windows can vary the effective density of the substrate material as a function of depth, and, by extension, its effective refractive index, providing anti-reflective properties. One practical surface modification is a closely-packed array of pyramidal or conical frusta structures, also known as “motheye” structures. As an incident electromagnetic wave traverses the height of the structures, it passes from a region (near the apices) where there is less material, with an effective refractive index close to 1.0, to regions (near the bases) where the region is almost entirely solid, having a refractive index close to that of the material comprising the structure.

Methods are presented for the fabrication of randomly arranged, antireflective and anti-scattering structures on a surface of an optical substrate. In certain aspects of the invention, such methods comprise providing a substrate, depositing a buffer layer on a surface of the substrate, depositing a metal film on the buffer layer, heating to effect rapid thermal annealing of the metal into nanoparticles, dry etching the substrate using the metal nanoparticles as a randomly arranged hard mask, and wet etching to remove the metal mask. In other aspects, randomly arranged, antireflective and anti-scattering structures are fabricated on two sides of a substrate to further increase the transmission of the optic.

The application describes the use of motheye structures as broadband, wide-incidence-angle antireflective (AR) and anti-scattering structures for high refractive index infrared windows and other transmissive optics. The effective refractive index transition must take place over a length that is on the order of half the longest incident wavelength, and the transverse spacing of the structures must be smaller than about half the shortest incident wavelength. For example, to provide a transition AR coating over both MWIR and LWIR bands (3-14 μm) for a ZnS, ZnSe, or other transmissive substrate, surface structures (cones, pyramids, pillars, or frusta) must be about 7 μm tall and have a base-base spacing of about 1.5 μm. As such, the mean ratio of structure height to base-base spacing is about 5.

In addition to being suitable for reducing reflections from and increasing transmittance through flat or planar window surfaces, the patterning fabrication method described in the application is amenable to non-planar or curved surfaces, thereby enabling increased transmission for sensor windows with more aerodynamically favorable shapes (e.g., domes and ogives), or for optical lenses in infrared imaging systems.

Other embodiments of the invention are directed to optics having random surface structures that have properties described in the examples shown below and in the Claims.

### EXAMPLES

The following examples as well as the figures exhibit various embodiments of the invention and are not intended to limit the scope of the invention.

### Example 1

### Modeling of Antireflective Surfaces Having Motheye Surface Structures on Optical Substrates

Using electromagnetic modeling, the inventors investigated the spectral reflectivity from an array of AlN cones patterned on top of a ZnS substrate. Modeling used a finite-difference time-domain computation, which solves Maxwell's equations for the electromagnetic field on a three-dimensional, finite-element grid. Linearly polarized plane-wave excitation was used on domains that had a 2×2 array of cones with cone spacing and base diameter of 300 nm, and a height of 1200 nm, yielding an aspect ratio of 4. Boundary conditions were Neumann for all three directions of the domain, indicating that mathematically, the array of cones was tiled ad infinitum. A perfect absorbing layer was placed below the ZnS substrate to absorb all transmitted light, and another perfect absorbing layer was placed some distance above the plane-wave source to absorb light that is reflected from the structure.

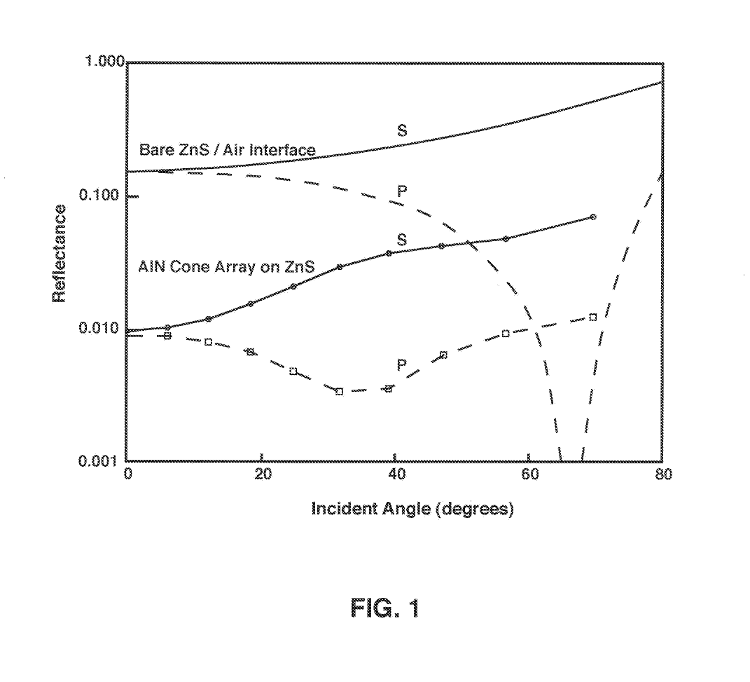

FIG. 1 illustrates the computed dependence of reflectance on incident angle for a motheye array of AlN conical structures on a ZnS substrate at a wavelength of 1 μm. The top two curves in the graph show the reflectance of S- and P-polarized light from a bare ZnS surface, as computed by the Fresnel reflectance. At the Brewster angle of 63°, the P-polarized component has zero reflectance. The bottom two plots show the reflectance as a function of incident angle for S- and P-polarized light on the patterned surface. Note that at incident angles from normal (0°) to 70°, the mean reflectance of the structured surface is approximately an order of magnitude smaller than the bare surface reflectivity. These results demonstrate that conical arrays have excellent spectral width and incident angle optical transmission characteristics, superior to those attainable with conventional multi-layer coatings.

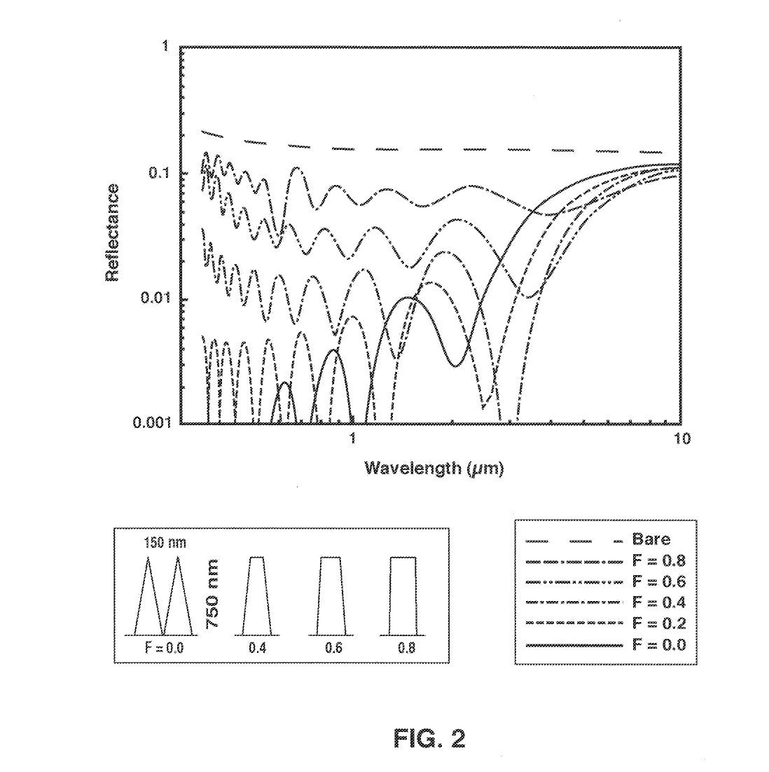

An additional factor that can influence the reflectance and scattering of a motheye AR coating is the detailed shape of the surface structures. A plot of the computed spectral reflectance of a ZnS optical window with motheye surface structures of truncated cones (frusta) of ZnS, having base diameters of 150 nm, base-base spacing of 150 nm, and heights of 750 nm (mean structure height/base-base spacing and aspect ratio=5) is shown in FIG. 2. The different curves show the reflectance as a function of the frustum parameter, F, which is defined as the ratio of the area of the top of the frustum to the area of the base. Thus, F=0 describes an array of right circular cones, while F=1 describes a rectangular close-packed array of cylinders, with intermediate values of F describing arrays of frusta, as depicted in the inset of the figure. A widely-spaced dashed line shows the reference spectral reflectance of a bare ZnS surface. It is clear that at short wavelengths, the array of cones (F=0) has the lowest reflectance, but at longer wavelengths (>3 μm) there appears to be a crossover, with lower reflectance being obtained for more truncated structures. Note that even for a close-packed array of almost-cylinders (F=0.8), there is still a factor of 2-3 reduction in the spectral reflectance.

### Example 2

### Synthesis of Random Surface Structures on Optical Substrates

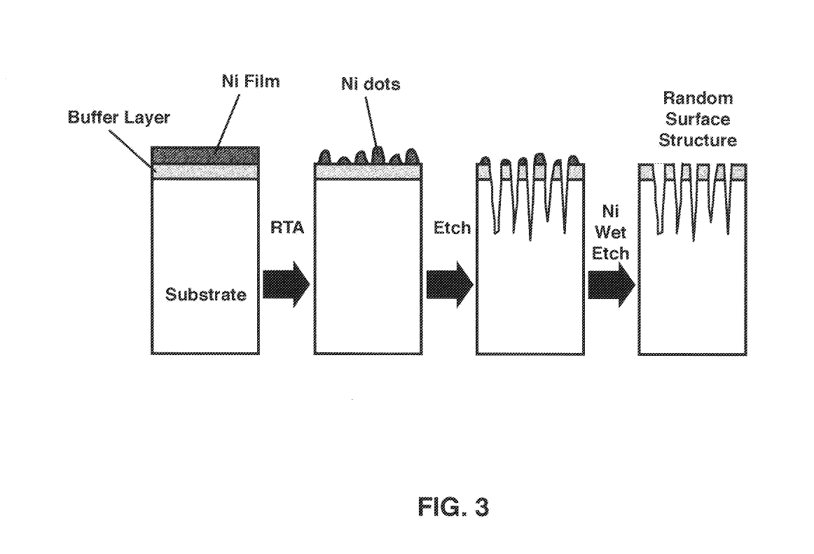

Random motheye (RM) surface structures were produced on ZnS and ZnSe optical components. A schematic representation of an exemplary form of the process is shown in FIG. 3. Optical window substrates were ultrasonically cleaned with acetone, methanol, and isopropanol to remove particles and contaminants on the surfaces. After cleaning, a buffer layer comprising a thin film of amorphous aluminum nitride (AlN) was deposited onto the window surfaces. Because ZnS and ZnSe window substrates are produced using a hot-press process, a typical optical component consists of unordered microcrystals that present a nanoscopically inhomogeneous surface. To produce a more uniform surface, a thin capping layer of sputter-deposited amorphous aluminum nitride (AlN) is laid down as a “buffer layer” coating or as a base layer to facilitate the subsequent formation of surface structures. The AlN buffer layer was deposited to a thickness of between 50 nm and 100 nm using magnetron sputtering without substrate heating. To improve the film adhesion a post annealing step at ˜400° C.-˜500° C. in a N₂ atmosphere was applied. AlN is highly transparent through the visible and infrared portions of the spectrum, displays high adhesion to most substrate materials, and is considerably more rugged than the ZnS/ZnSe native window surfaces. The AlN layer provides a homogeneous, amorphous, smooth, and non-wettable surface as a starting point for subsequent process steps, regardless of the layer thickness. In exemplary embodiments, an AlN buffer layer has been used due to its chemical and physical stability and low surface energy, as well as easy fabrication. However, other materials, including by way of example, Si₃N₄, ZrO₂, and SiO₂ can also be used as buffer layers for methods and optics of the invention.

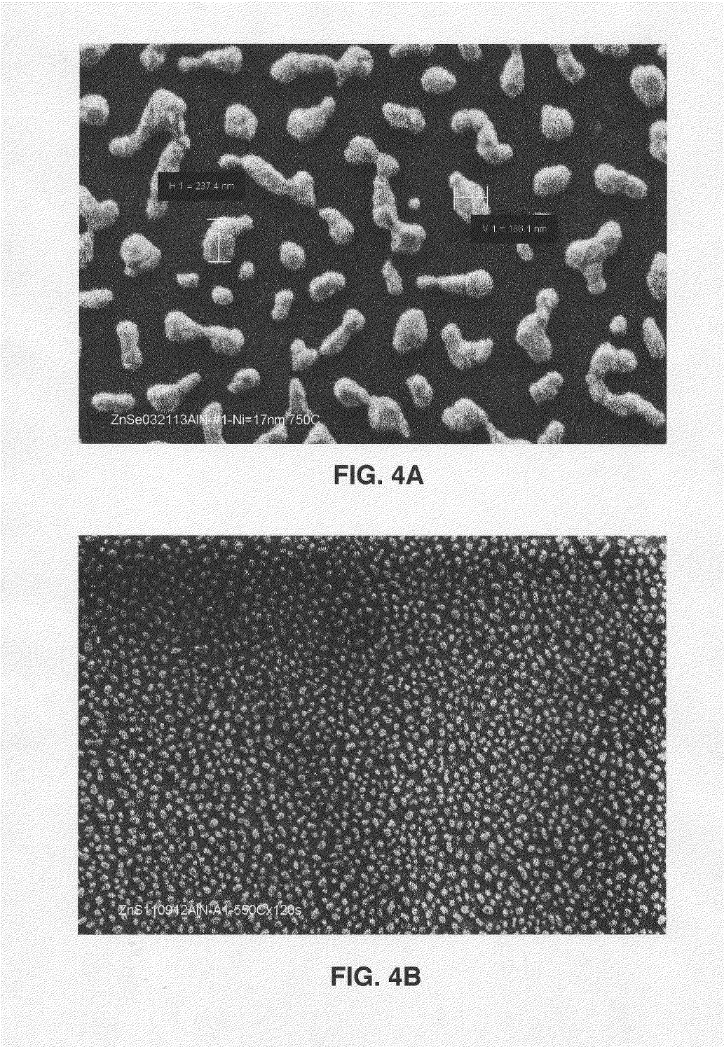

After deposition of the AlN, a thin (3 nm-30 nm) layer of Ni was evaporated onto the buffer-coated substrate using e-beam evaporation. Rapid thermal anneal (RTA) was performed in an inert gas atmosphere (N₂, or forming gas) while the temperature was increased from 500° C. to about 1000° C. The ramping from room temperature to peak temperature was performed over about 15 sec to 30 sec and the time at peak temperature was 120 sec. The RTA step causes the Ni layer to melt and reflow into sub-micron Ni nanoparticles (also referred to as “dots” or islands) on top of the AlN surface. The mean diameter and mean spacing between the centers of adjacent Ni dots is primarily a function of the initial Ni layer thickness (FIG. 4A and FIG. 4B). FIG. 4A shows Ni dots formed from an initial Ni film of 17 nm on an AlN buffer layer over a ZnSe substrate. In this instance, the resulting Ni dots had a mean diameter of approximately 200 nm and a mean spacing of approximately 200 nm. FIG. 4B shows Ni dots from an initial Ni film of 3.9 nm on an AlN buffer layer over a ZnS substrate. In this instance, the resulting Ni dots had a mean diameter of approximately 25 nm and a mean spacing of approximately 25 nm.

After formation of the Ni dots, a dry etching process was employed using an inductively-coupled plasma (ICP) etcher. The Ni dots served as a dry etching mask for removing material only in those areas not covered by Ni. Etching of the AlN buffer layer and the ZnS or ZnSe substrate was performed using inductively coupled plasma reactive ion etching (ICP-RIE). The etchant gas was chlorine-based, using BCl₃ and/or Cl₂ mixed with H₂. Inert gases such as Ar or N₂ were added as necessary to increase physical sputtering and etching rate. To achieve anisotropic etching, flow rates of the component gases were monitored and adjusted as necessary. Exemplary flow rates were BCl₃ @ 5 standard cubic centimeters per minute (sccm), H₂ @ 10 sccm, and Ar @ 5 sccm. The vacuum pressure was 5-10 mTorr. The RF power was set to 100-150 W depending on the size and thickness of Ni dots. ICP power was approximately 700-1000 W. The ZnS or ZnSe window was kept at room temperature during etching, and the etching time was varied to evaluate the effect on the production of the random surface structures. Depending upon the initial thickness of the AlN layer and the etching duration, the etch depth may extend only into the AlN layer or through the AlN layer and into the substrate bulk. When etching extended through the buffer coating and into the substrate, the resulting surface structures comprised substrate material on the bottom and AlN on top, and Ni dots on top of the AlN. A final wet etch processing step (Ni wet etch) using FeCl₃ solution was performed to remove the remaining Ni dots from the tops of the structures and was followed by washing, rinsing, and drying to complete the process.

By varying the initial thickness of the Ni film, the size (mean diameter) and spacing (mean center-to-center distance) between the Ni dots can be adjusted to desired parameters. Hence, the average diameters of the resulting motheye structures and the mean spacings between the motheye structures can be exquisitely adjusted. By way of example, a thin Ni film of 3.9 nm produces dots having a mean diameter of approximately 25 nm and a mean spacing of approximately 25 nm. The metal dots protect the buffer layer and substrate from etching, thereby defining the diameter and base-base spacing of the resulting motheye structures. Smaller Ni dots would lead to the formation of narrower and more numerous structures having a smaller mean base-base spacing. Larger Ni dots, created by the deposition of a thicker Ni film (e.g., 17 nm) would lead to the formation of wider and less numerous structures having a larger mean base-base spacing. By varying the dry etching parameters (e.g., duration, plasma power, type of etchant gases, flow rate and vacuum pressure) and the initial thickness of the buffer layer, the etch depth into the buffer layer and/or into the substrate and the etching profile can be adjusted, thereby adjusting the height and shape of the motheye structures that are fabricated. Therefore, adjusting the initial Ni film and buffer thickness and the etch parameters enables the fabrication of surface structures having a wide range of mean diameters, heights, base-base spacings, and frustum parameters.

The exemplary substrates used here, ZnS and ZnSe, were chosen because of their wide spectral transmission and ubiquitous application as windows and refractive components for infrared optical systems. However, other optical substrates can be used to practice the invention, including those made from fused silica, and as examples of other infrared window materials, those made from Ge, GaAs, GaP, CdTe, HgCdTe, BaF₂, CaF₂, CaF₂As, Y₂O₃, MgO, AlON, spinel, and sapphire.

In exemplary embodiments, Ni was used as the metal film for the formation of the random mask, following a rapid thermal annealing process. However, other metals could be used in methods of the invention, including for example Ag and Au.

### Example 3

### Analysis of Fabrication

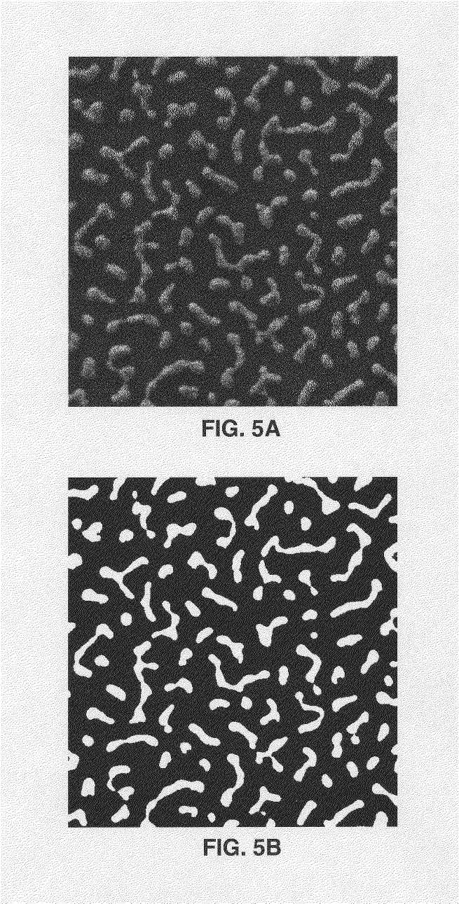

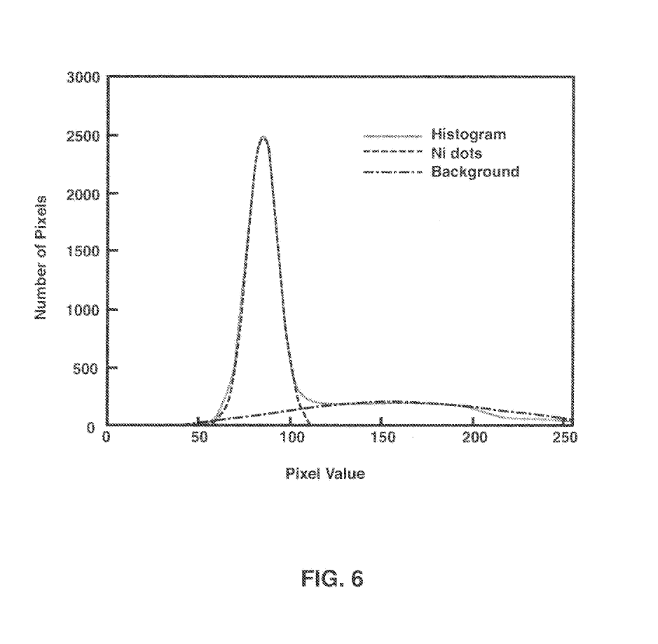

The characteristic quasi-periodic length scale and filled fraction of Ni etch masks were determined using the radial 2D autocorrelation function of scanning electron microscope images of the Ni dots. The parameters extracted from this process are useful not only for characterization of the structure, but also as input for generation of simulation model parameters. Scanning electron micrographs (SEM) were acquired for samples prior to the etch step of the fabrication process. The samples comprised a bare substrate, optionally a very thin (tens of nm) buffer layer, with Ni dots distributed thereon. Using a uniformly “illuminated” SEM image (FIG. 5A), a binarized image (FIG. 5B) was prepared. The brightness histogram of the image separated neatly into a bimodal distribution, representing the dark and light areas of the image (FIG. 6). The “dark” portion of the histogram more closely resembled a Gaussian distribution, probably due to the fact that the dark portion of the image was a roughly flat, uniformly illuminated, noisy background, while the nickel dots had surface curvature and were hence subject to non-uniform illumination, skewing their brightness distribution. The image processing procedure included fitting the larger “dark” peak to a Gaussian distribution, taking note of the position of the maximum of the fit. This was followed by subtraction of the fit from the histogram. The resulting difference distribution was fit using a second Gaussian distribution, and the brightness threshold for binarization was computed as the average brightness of the two maxima.

The SEM image was binarized (FIG. 5B) by assigning a value of one to all pixels that exceeded the threshold and a value of 0 to all pixels that did not exceed the threshold. From the binarized image, the filled fraction (f) was found by summing over all pixels and dividing by the total number of pixels in the image. This quantity was a measure of the fractional area occupied by the Ni mask material.

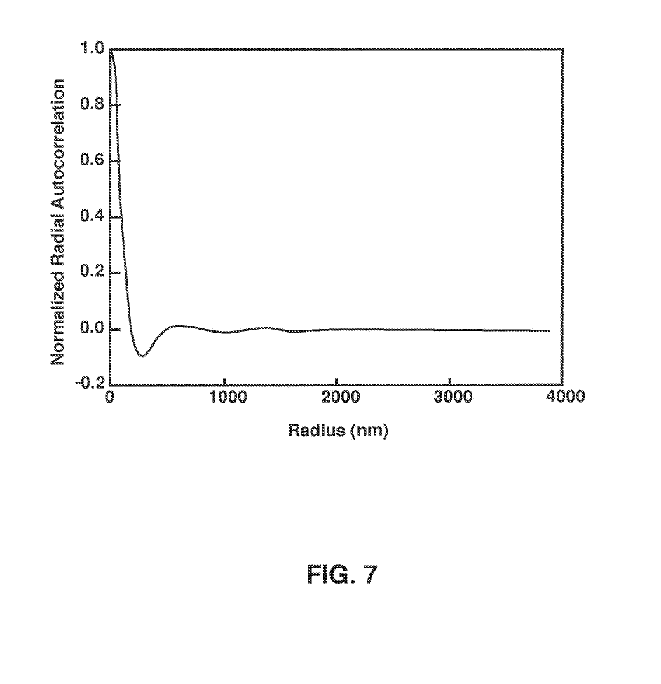

After threshold value assignment, the characteristic “periodicity”, R, of the random nickel dot mask was extracted by computing the normalized 2D autocorrelation function of the binarized image and averaging radially:

$$AC ( x , y ) = \frac{{\sum }_{x , y} ( I ( x , y ) - μ ) \cdot ( I ( {x}_{0} , {y}_{0} ) - μ )}{{\sum }_{x , y} {( I ( x , y ) - μ )}^{2}}$$

$$ACR ( r ) = \frac{{\sum }_{x , y : {x}^{2} + {y}^{2} = {r}^{2}} AC ( x , y )}{{\sum }_{x , y : {x}^{2} + {y}^{2} = {r}^{2}} 1}$$

where I(x, y) is the image intensity at the pixel (x, y) and μ is the average image intensity (which is equal to the filled fraction, f). A clear minimum was observed in the radial average of the 2D autocorrelation (FIG. 7), and the position of this first minimum was taken to be the approximate radius R of a quasi-periodic “unit cell” in the image.

To a first approximation, the Ni dots were considered to have a roughly circular shape with typical radius, r, so that their area was proportional to r², while the area of the unit cell was proportional to R². From above, the fraction of the image filled by the dots was approximately f≈r²/R², so that the measure of Ni dot radius was approximated as r≈R\sqrt{f}.

For a periodic lattice of uniformly sized circular dots, this relation holds exactly with the parameters r, R describing the radius of every dot and its surrounding periodic unit cell. For a distribution of dots of non-uniform size and placement, it holds only approximately and serves primarily to provide a rough characterization of the nickel dot size. Since the parameter f is proportional to the sum of the area of each Ni dot, each of which is, in turn, proportional to r², the quantity \sqrt{f} is proportional to the root mean square (RMS) measure of the Ni dot radius. This number was then scaled by the periodicity R of the Ni dot mask to provide the estimated RMS Ni dot radius r.

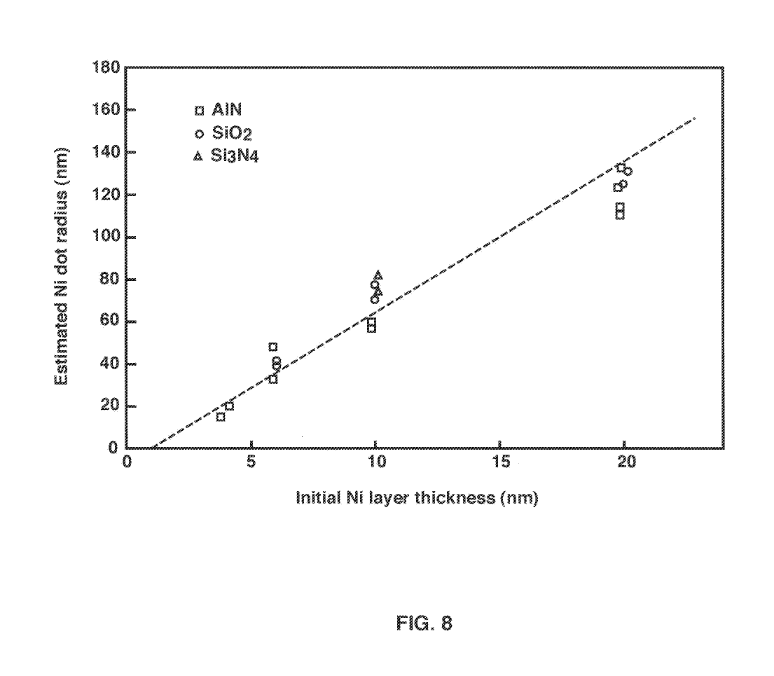

The autocorrelation method was used to determine the dependence of Ni dot size, fill fraction, and unit cell radius on the initial Ni layer thickness that was deposited prior to annealing (Table 1). A variety of annealing conditions and buffer layer materials were used to fabricate nickel dots for the various initial Ni layer thicknesses. Systematic dependences on the fabrication parameters were sought to provide insight on the Ni dot formation process. However, it was found that the various buffer layer materials and RTA parameters did not appear to significantly influence the Ni dot size. As shown in FIG. 8, the Ni dot size as a function of initial Ni layer thickness was fit fairly well by a linear relation for buffer layers of AlN, SiO₂, and SiN. The error bars in FIG. 8 are due to the uncertainty in R due to ±1 pixel uncertainty in the position of the radially-averaged autocorrelation minimum and due to the uncertainty in f due to an uncertainty of ±3 eight-bit intensity units (0-255) when choosing the image threshold value.

TABLE 1
Dependence of Nickel Dot Size, Fill Fraction, and Unit
Cell Radius on the Initial Nickel Layer Thickness.

| Buffer | | | | | |
|---|---|---|---|---|---|
| Layer | h (nm) | RTA | f | R (nm) | r (nm) |
| AlN | 3.9 | 550 C. × 120 s | 0.230767 | 31.5946 | 15.17748 |
| AlN | 4.2 | 550 C. × 120 s | 0.237078 | 40.5665 | 19.7521 |
| AlN | 6 | 600 C. × 120 s | 0.217206 | 71.4033 | 33.27777 |
| AlN | 6 | 700 C. × 120 s | 0.201289 | 107.631 | 48.28891 |
| AlN | 10 | 600 C.-25 s ramp | 0.286626 | 106.941 | 57.2535 |
| AlN | 10 | 700 C. × 120 s | 0.308765 | 102.998 | 57.23251 |
| AlN | 10 | 600 C. × 120 s | 0.311811 | 107.572 | 60.06825 |
| AlN | 20 | 750 C. × | 0.294407 | 228.226 | 123.8338 |
| | | 120 s-2step | | | |
| AlN | 20 | 750 C. × | 0.209564 | 246.455 | 112.8226 |
| | | 120 s-2step | | | |
| AlN | 20 | 750 C. × | 0.204794 | 292.046 | 132.163 |
| | | 120 s-2step | | | |
| SiO₂ | 6 | 600 C. × 120 s | 0.221012 | 80.6393 | 37.91008 |
| SiO₂ | 6 | 600 C. × 120 s | 0.215024 | 84.3163 | 39.09804 |
| SiO₂ | 10 | 700 C. × 120 s | 0.182798 | 162.786 | 69.59896 |
| SiO₂ | 10 | 700 C. × 120 s | 0.215998 | 165.954 | 77.12809 |
| SiO₂ | 20 | 750 C. × 120 s | 0.346173 | 220.673 | 129.8362 |
| SiO₂ | 20 | 750 C. × 120 s | 0.322353 | 219.762 | 124.7724 |
| SiN | 10 | 600 C.-25 s ramp | 0.280682 | 139.634 | 73.9773 |
| SiN | 10 | 600 C.-45 s ramp | 0.265319 | 156.134 | 80.42326 |

h, initial Ni layer thickness; RTA, rapid thermal anneal conditions (45 sec ramp unless otherwise noted); f, Ni dot pattern fill fraction; R, estimated quasiperiodic unit cell radius; r, estimated Ni dot radius.

### Example 4

### Analysis of Optical Transmittance

AlN coated multi-spectral ZnS (CLEARTRAN™, Dow Chemical Co.) and ZnSe windows (25 mm in diameter) were prepared with random surface structures for optical transmission studies. AlN buffer coatings 20 nm thick were deposited in a custom magnetron sputtering tool using an Al target in a nitrogen-rich plasma. Ni films of thickness ranging from 3.9 nm to 30 nm were deposited with an electron-beam metal evaporator. RTA was performed at temperatures between 400° C. and 1000° C., for durations between 30 sec and 200 sec. Dry etching was performed with an Oxford ICP etcher using a halogen-containing plasma. Post-etch removal of Ni was accomplished by dipping the window in an aqueous FeCl₃ solution for ˜1 min. These fabrication steps provided a means for the systematic variation of Ni dot size and spacing, resulting in random motheye surface structures that had size-dependent optical properties.

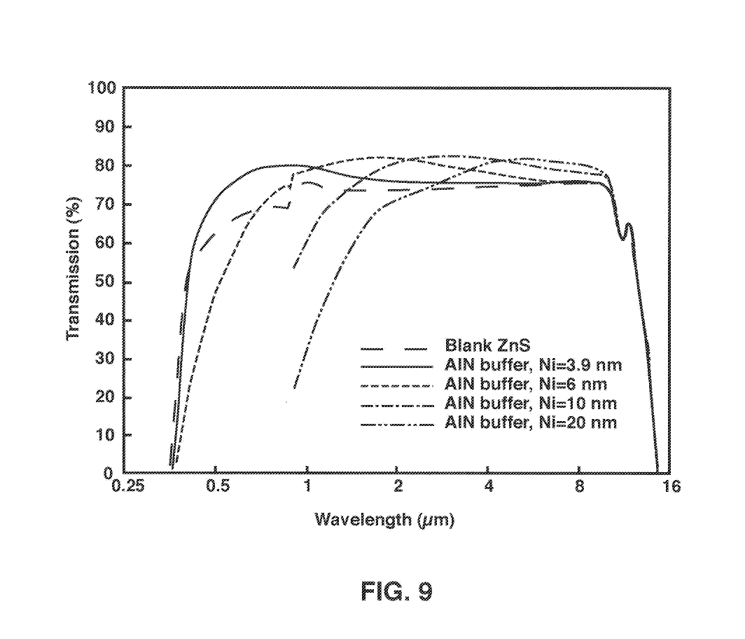

FIG. 9 shows the normal-incidence spectral transmittance of ZnS windows with AR random motheye (RM) surface structures fabricated with different structure feature base-base distances, as dictated by the initial thickness of the evaporated Ni layer. The structures were fabricated on only one side of the window, so the transmittance increase was less when compared to that observed with a window that had both sides treated. In all cases, the approximate average ratio of structure height to base-base spacing of the etched RM structures was about 4. Broadening of the spectral transmission peak could be accomplished with surface structures having larger aspect ratios and larger ratios of mean structure height to mean base-base spacing, illustrating that very good control over transmission maximum wavelength and spectral width was achieved using the RM hard mask fabrication process. The results in FIG. 9 demonstrate that broadband (visible band through the LWIR band) AR RM surface coatings could be achieved on infrared substrates with good process control.

In addition to the normal-incidence spectral transmittance, the performance of the AR RM structures as a function of incident angle, and for both S- and P-polarizations, was evaluated. For these measurements, a custom FTIR reflectometer was used. The reflectometer is a combination of the external beam port of a commercial FTIR instrument with some custom optics and an external detector. A gold-coated mirror was used as a unity-reflectance standard, and reflectance was measured, using an untreated blank ZnSe window and a ZnSe window having a AlN buffer layer 20 nm thick, and having random surface structures with a ratio of mean structure height to mean base-base spacing of 5, over the angular range from 20° to 80° from normal incidence, and over a wavelength range from 2 μm to 16 μm.

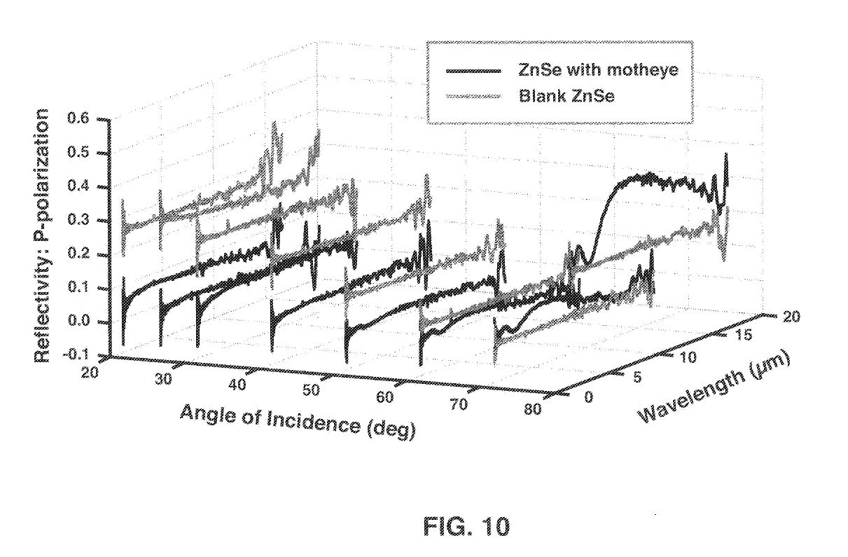

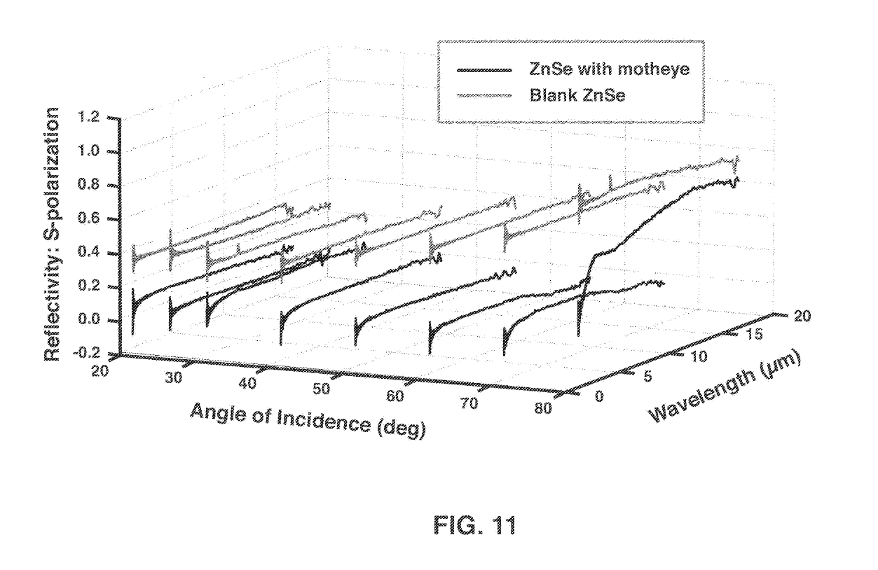

The spectral-angular reflectance for P-polarized light appears in FIG. 10, and the spectral-angular reflectance for S-polarized light is shown in FIG. 11. For the P-polarization data, the reflectance of the blank window was relatively flat as a function of wavelength and decreases as a function of angle up to ˜70°, which is the Brewster angle for ZnSe. Beyond ˜70° the reflectance of the P-polarized light increased sharply. For the window with the RM surface structures, the spectral reflectance was about 0.07 over the entire spectral range, and over angles out to about 70°, where some variation in spectral reflectivity began to occur. At angles larger than 70°, the overall reflectance rose sharply. For both windows, the reflectance has to asymptote to unity at grazing incidence. The decrease in the reflectance at the shortest wavelengths was probably due to an increase in surface scattering at short wavelengths. The short-wavelength scattering is expected since the surface structures on this sample were optimized for the MWIR and LWIR bands.

For the S-polarization (FIG. 11), the reflectance of the blank window was relatively flat as a function of wavelength and increased monotonically as a function of angle, as predicted by the Fresnel equations. For the window with the random surface structures, the spectral reflectance was about 0.08 over the entire spectral range, and over angles out to about 70°, where the overall reflectance rose sharply.

The measured reflectance data demonstrate that the AR RM surface structures provided not only broad anti-reflection characteristics at normal incidence, but exhibited only small increases in reflectivity with incident angle out to angles as large as 70°.

### Example 5

### Analysis of Antireflective Properties for an Optic Having Random Motheye Surface Structures on Two Sides of the Window

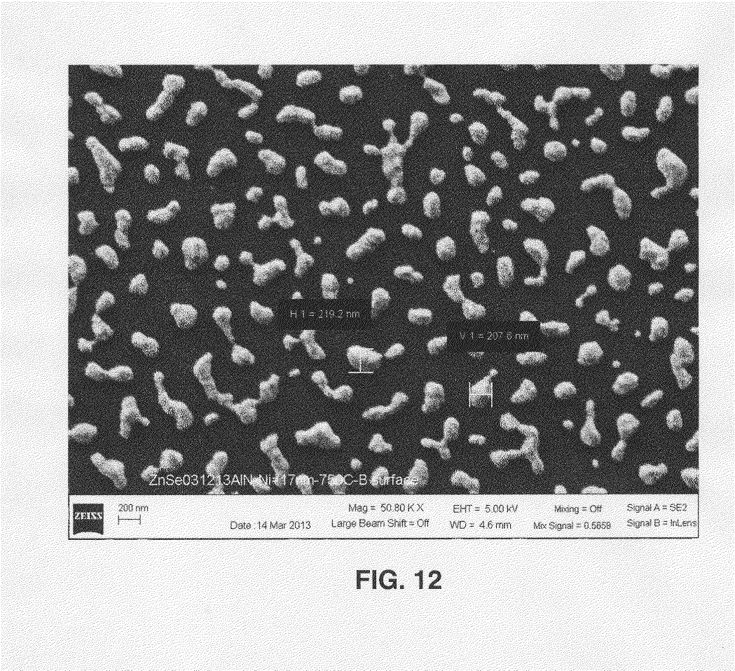

To demonstrate the antireflective properties of RM structures for practical optical components, a 25 mm diameter ZnSe transmissive optical window was treated to produce random surface structures on both sides of the window, and the spectral transmittance of the resulting window was measured. The dimensions of the RM surface structures were optimized for high transmittance across the MWIR and extended LWIR (3 μm to 18 μm), a wavelength span of ˜2.6 octaves. FIG. 12 shows an SEM image of the initial Ni dot etch mask that resulted from the RTA of a 17 nm thick initial Ni film.

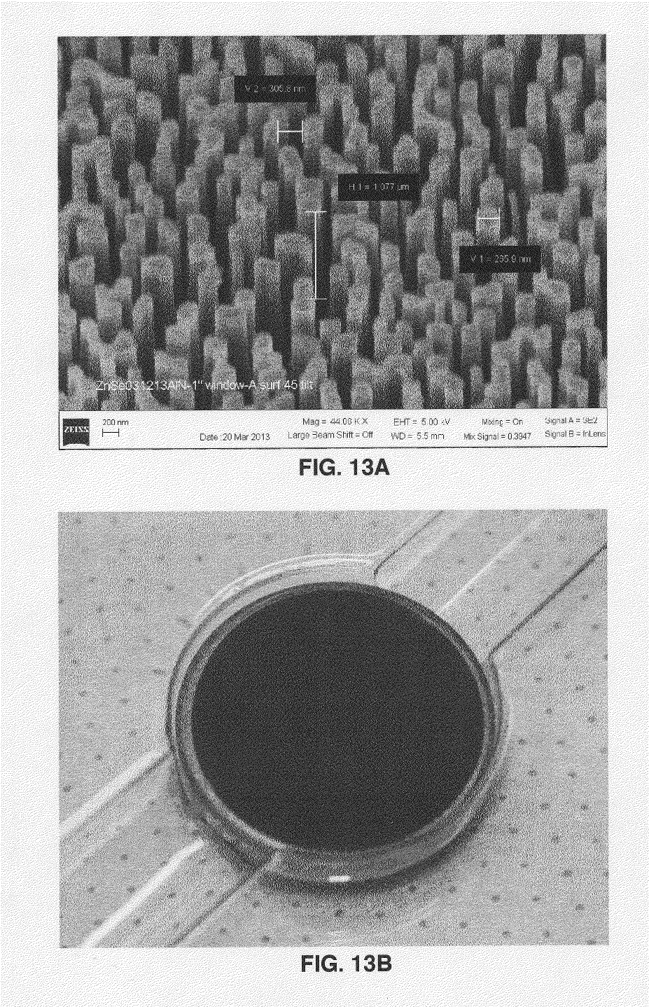

FIG. 13A shows the RM structures after the ICP etch process step. The pillar shapes of the RM structures are clearly visible and are etched into the ZnSe substrate. The 20 nm thick AlN buffer layer is visible as a lighter shaded region at the top of the pillars. Measurements indicate that the mean aspect ratio and the average ratio of structure height to base-base spacing is approximately 5. Macroscopically, the RM structures are very uniform over the entire clear aperture on both sides of the window. The color of the window is darker than an untreated ZnSe optical component because of the increased scattering produced by the RM-treated surfaces at the shorter VIS wavelength (FIG. 13B).

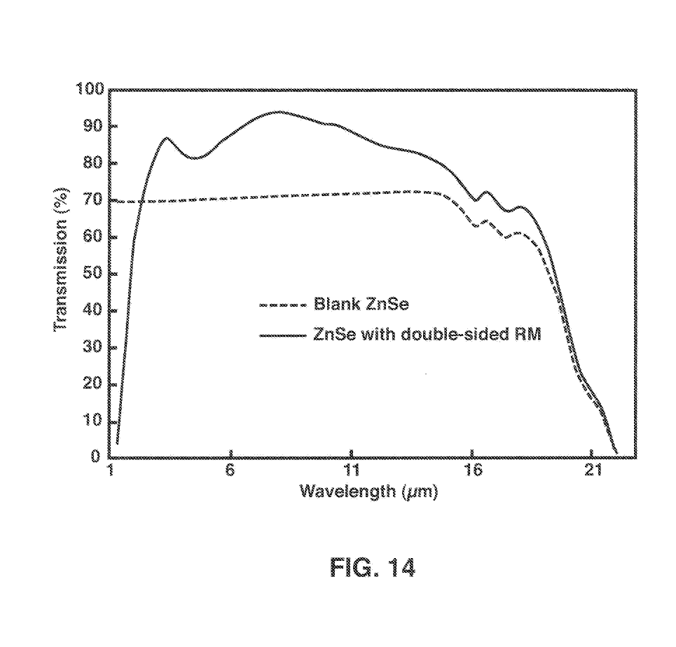

The spectral transmittance of the ZnSe window having random surface structures on each side of the window compared with that of a blank ZnSe window is shown in FIG. 14. Fabrication of surface structures on both sides of the window provided significant anti-reflective characteristics and increased transmission over the entire 3 μm to 18 μm wavelength range, with transmittance exceeding 0.9 in the short-wavelength portion of the LWIR band.

What is claimed is:

1. An optic having an antireflective surface comprising:
a substrate, a buffer layer deposited on at least one side of the substrate, and a plurality of surface structures formed by reactive ion etching of the buffer-coated substrate, wherein the plurality of structures are configured to reduce reflection of electromagnetic radiation having an incident angle from 0° to 70° over a region of at least 2.0 octaves within the electromagnetic spectrum region of 350 nm to 18,000 nm.

2. The optic of claim 1 wherein the structures are configured to reduce reflection within the electromagnetic spectrum region of 3,000 nm to 18,000 nm.

3. The optic of claim 1 wherein the buffer layer comprises AlN, SiO₂, ZrO₂, or Si₃N₄.

4. The optic of claim 3 wherein the buffer layer comprises AlN.

5. The optic of claim 1 wherein the ratio of the mean height of structures to mean base-base spacing of adjacent structures is from 4 to 12.

6. The optic of claim 1 wherein the substrate comprises ZnS, ZnSe, Ge, GaAs, GaP, CdTe, HgCdTe, BaF₂, CaF₂, CaF₂As, Y₂O₃, MgO, AlON, spinel, sapphire, or fused silica.

7. The optic of claim 6 wherein the substrate comprises ZnS or ZnSe.

8. The optic of claim 1 further comprising a second buffer layer deposited on a second side of the substrate opposite the first side, and a second plurality of surface structures formed by reactive ion etching of the second buffer-coated substrate, wherein the second plurality of structures are configured to reduce reflection of electromagnetic radiation having an incident angle from 0° to 70° over a region of at least 2.0 octaves within the electromagnetic spectrum region of 350 nanometers (nm) to 18,000 nm.

9. The optic of claim 1 wherein the substrate comprises a non planar surface.

10. The optic of claim 8 wherein the substrate comprises a non planar surface.

11. A method of forming a plurality of random surface structures on an optical substrate, comprising:
(a) providing a substrate;
(b) depositing a buffer layer on a surface of the substrate;
(c) depositing a metal film on the buffer layer;
(d) heating to effect annealing of the metal into randomly arranged nanoparticles;
(e) dry etching the buffer-coated substrate; and
(f) performing a wet etch to remove metal nanoparticles.

12. The method of claim 11 wherein the ratio of mean height to mean base-base spacing of the formed surface structures is from 3 to 12.

13. The method of claim 12, wherein the height of the formed surface structures is from 0.5 μm to 3.5 μm.

14. The method of claim 11 wherein the frustum parameters of the formed structures are from 0 to 0.8.

15. The method of claim 14 wherein the frustum parameters are from 0 to 0.4.

16. The method of claim 11, wherein the metal film is deposited to an initial thickness of between 4 nm and 20 nm

17. A method of forming a plurality of random surface structures on an optical substrate, comprising:
(a) providing a substrate comprising ZnSe;
(b) depositing a buffer layer comprising AlN on a surface of the substrate;
(c) depositing a metal film comprising Ni on the buffer layer;
(d) heating to effect annealing of the Ni into randomly arranged nanoparticles;
(e) dry etching the buffer-coated substrate; and
(f) wet etching to remove metal nanoparticles.
